(19) United States
(12) Patent Application Publication
(10) Pub. No.: US 2025/0080840 A1
(43) Pub. Date: Mar. 6, 2025

(54) FOCUS CONTROL DEVICE, IMAGING APPARATUS, FOCUS CONTROL METHOD, AND PROGRAM

(71) Applicant: FUJIFILM Corporation, Tokyo (JP)

(72) Inventor: Hitoshi SAKURABU, Saitama-shi (JP)

(73) Assignee: FUJIFILM Corporation, Tokyo (JP)

(21) Appl. No.: 18/798,771

(22) Filed: Aug. 8, 2024

(30) Foreign Application Priority Data
Aug. 31, 2023 (JP) 2023-141819

(51) Int. Cl. H04N 23/67; H04N 17/00

(52) U.S. Cl. CPC H04N 23/672; H04N 17/002

(57) ABSTRACT

There is provided a focus control device that determines a defocus amount for driving a focus lens, the focus control device including: a processor; and a memory, in which the processor is configured to: obtain, in a state where a plurality of areas are set in an imaging region, the number of the areas of which reliabilities of defocus amounts obtained from the plurality of areas are low; and determine the defocus amount for driving the focus lens based on an index related to a plurality of the defocus amounts in a case where the number is equal to or larger than a first threshold value.

### CROSS-REFERENCE TO RELATED APPLICATIONS

The present application claims priority under 35 U.S.C. § 119 to Japanese Patent Application No. 2023-141819 filed on Aug. 31, 2023. The above application is hereby expressly incorporated by reference, in its entirety, into the present application.

### BACKGROUND

### 1. Technical Field

The technology of the present disclosure relates to a focus control device, an imaging apparatus, a focus control method, and a program.

### 2. Description of the Related Art

JP1999-133294A (JP-H11-133294A) discloses a focus detection device that amplifies an accumulated-charge signal output from a photoelectric conversion element unit by a parameter set in an amplification unit, reads out the amplified accumulated-charge signal as a subject image signal, determines whether or not the subject image signal has an appropriate value for execution of focus detection by a determination unit, executes subsequent focus detection calculation or the like in a case where the subject image signal is appropriate, changes the amplification parameter of the amplification unit in a case where the subject image signal is inappropriate, amplifies the accumulated-charge signal again, reads out the accumulated-charge signal again as the subject image signal, and obtains the subject image signal appropriate for focus detection.

JP2012-142952A discloses an imaging apparatus that captures an image formed by an optical system by using an imaging element. The imaging element includes an image combining unit that generates data of a pair of images by receiving a luminous flux passing through each of different regions on an exit pupil of an optical system and generates a composite image by adding the data of the pair of images. An image processing unit detects a defocus amount distribution for the composite image in a captured image and performs, on the image data, processing based on the defocus amount distribution.

### SUMMARY

An object of the technology of the present disclosure is to provide a focus control device, an imaging apparatus, a focus control method, and a program capable of improving focusing accuracy in a case where a reliability of a defocus amount is low.

In order to achieve the above object, according to the present disclosure, there is provided a focus control device that determines a defocus amount for driving a focus lens, the focus control device including: a processor; and a memory, in which the processor is configured to: obtain, in a state where a plurality of areas are set in an imaging region, the number of the areas of which reliabilities of defocus amounts obtained from the plurality of areas are low; and determine the defocus amount for driving the focus lens based on an index related to a plurality of the defocus amounts in a case where the number is equal to or larger than a first threshold value.

Preferably, the index is an index based on a frequency of the plurality of defocus amounts.

Preferably, the processor is configured to determine a median value of the plurality of defocus amounts as the defocus amount for driving the focus lens.

Preferably, the processor is configured to determine the defocus amount for driving the focus lens based on a distance to a subject corresponding to the defocus amount in a case where the number is smaller than the first threshold value.

Preferably, the processor is configured to determine a nearest value of the plurality of defocus amounts as the defocus amount for driving the focus lens in a case where the number is smaller than the first threshold value.

Preferably, the processor is configured to: divide each of the plurality of areas into a plurality of blocks, and determine whether or not each of the plurality of blocks is a defective block based on a content rate of a signal that affects a decrease in the reliability and is included in each of the blocks; and determine that the reliability is low in a case where the number of the defective blocks is equal to or larger than a second threshold value.

Preferably, the signal that affects the decrease in the reliability is a signal that exceeds a limit of performance of an imaging element.

Preferably, the reliability is related to saturations of a plurality of pixels included in the area, and the processor is configured to determine the reliability based on the saturations.

Preferably, the processor is configured to: divide each of the plurality of areas into a plurality of blocks, and determine whether or not each of the blocks is a saturated block based on a content rate of the saturated pixels in each of the blocks; and determine that the reliability is low in a case where the number of the saturated blocks is equal to or larger than a second threshold value.

Preferably, the processor is configured to: determine the area in which the number of the saturated blocks is equal to or larger than the second threshold value, as a first area; and set a median value of defocus amounts corresponding to the plurality of blocks included in the first area, as a defocus amount of the first area.

Preferably, the processor is configured to: determine the area in which the number of the saturated blocks is smaller than the second threshold value, as a second area; and set a nearest value of defocus amounts corresponding to the plurality of blocks included in the second area, as a defocus amount of the second area.

Preferably, the processor is configured to: perform a plurality of pieces of filtering processing of which frequency characteristics are different on a plurality of pixels included in the area; and determine the reliability based on evaluation values obtained by the plurality of pieces of filtering processing.

Preferably, the processor is configured to: divide each of the plurality of areas into a plurality of blocks, and determine whether or not each block is a high-frequency block based on the evaluation values for each block; and determine that the reliability is low in a case where the number of the high-frequency blocks is equal to or larger than a second threshold value.

Preferably, the processor is configured to: determine the area in which the number of the high-frequency blocks is equal to or larger than the second threshold value, as a first area; and set a median value of defocus amounts corresponding to the plurality of blocks included in the first area, as a defocus amount of the first area.

Preferably, the processor is configured to: determine the area in which the number of the high-frequency blocks is smaller than the second threshold value, as a second area; and set a nearest value of defocus amounts corresponding to the plurality of blocks included in the second area, as a defocus amount of the second area.

Preferably, the processor is configured to: calculate a first defocus amount by performing correlation calculation based on first two-dimensional images generated by performing first filtering processing on two-dimensional images represented by a plurality of pixels included in the block; calculate a second defocus amount by performing correlation calculation based on first one-dimensional images generated by performing the first filtering processing on one-dimensional images obtained by performing vertical addition on the two-dimensional images; calculate a third defocus amount by performing correlation calculation based on second two-dimensional images generated by performing, on the two-dimensional images, second filtering processing having different frequency characteristics from the first filtering processing; calculate a fourth defocus amount by performing correlation calculation based on second one-dimensional images generated by performing the second filtering processing on the one-dimensional images; and determine that the block is the high-frequency block in a case where a difference between the first defocus amount and the third defocus amount is larger than any one of a difference between the first defocus amount and the second defocus amount or a difference between the third defocus amount and the fourth defocus amount.

Preferably, the reliability is related to contrast of a plurality of pixels included in the area, and the processor is configured to determine the reliability based on an evaluation value related to the contrast.

Preferably, the processor is configured to: divide each of the plurality of areas into a plurality of blocks, and determine whether or not each block is a low-contrast block based on the evaluation value for each block; and determine that the reliability is low in a case where the number of the low-contrast blocks is equal to or larger than a second threshold value.

Preferably, the processor is configured to: determine the area in which the number of the low-contrast blocks is equal to or larger than the second threshold value, as a first area; and set a median value of defocus amounts corresponding to the plurality of blocks included in the first area, as a defocus amount of the first area.

Preferably, the processor is configured to: determine the area in which the number of the low-contrast blocks is smaller than the second threshold value, as a second area; and set a nearest value of defocus amounts corresponding to the plurality of blocks included in the second area, as a defocus amount of the second area.

Preferably, the processor is configured to determine whether or not the block is the low-contrast block for each block based on a shape of a correlation curve obtained by performing correlation calculation based on a brightness distribution of the plurality of pixels included in the block or the plurality of pixels included in the block.

According to the present disclosure, there is provided an imaging apparatus including: the focus control device; and an imaging element.

According to the present disclosure, there is provided a focus control method of determining a defocus amount for driving a focus lens, the focus control method including: obtaining, via a processor, in a state where a plurality of areas are set in an imaging region, the number of the areas of which reliabilities of defocus amounts obtained from the plurality of areas are low; and determining, via the processor, the defocus amount for driving the focus lens based on an index related to a plurality of the defocus amounts in a case where the number is equal to or larger than a first threshold value.

According to the present disclosure, there is provided a program causing a processor to execute processing of determining a defocus amount for driving a focus lens, the processing including: obtaining, in a state where a plurality of areas are set in an imaging region, the number of the areas of which reliabilities of defocus amounts obtained from the plurality of areas are low; and determining the defocus amount for driving the focus lens based on an index related to a plurality of the defocus amounts in a case where the number is equal to or larger than a first threshold value.

### BRIEF DESCRIPTION OF THE DRAWINGS

Exemplary embodiments according to the technique of the present disclosure will be described in detail based on the following figures, wherein:

FIG. 1 is a diagram illustrating an example of a configuration of an imaging apparatus,

FIG. 2 is a diagram illustrating an example of a configuration of an imaging pixel,

FIG. 3 is a diagram illustrating an example of a configuration of a phase difference detection pixel,

FIG. 4 is a diagram illustrating an example of pixel arrangement of an imaging sensor,

FIG. 5 is a block diagram illustrating an example of a functional configuration of a processor,

FIG. 6 is a diagram illustrating an example of an AF area,

FIG. 7 is a diagram illustrating an example of a plurality of small areas,

FIG. 8 is a diagram illustrating an example of a plurality of blocks,

FIG. 9 is a diagram illustrating an example of correlation calculation processing,

FIG. 10 is a diagram illustrating an example of correlation calculation processing including filtering processing,

FIG. 11 is a diagram illustrating an example of filtering processing,

FIG. 12 is a diagram illustrating details of correlation calculation processing,

FIG. 13 is a diagram illustrating an example of a correlation curve,

FIG. 14 is a diagram illustrating an example of first selection processing,

FIG. 15 is a diagram illustrating an example of second selection processing,

FIG. 16 is a diagram illustrating an example of second selection processing,

FIG. 17 is a flowchart illustrating a flow of a driving defocus amount acquisition processing,

FIG. 18 is a flowchart illustrating an example of reliability determination processing,

FIG. 19 is a flowchart illustrating an example of a flow of the overall processing executed by the imaging apparatus,

FIG. 20 is a flowchart illustrating reliability determination processing according to a first modification example,

FIG. 21 is a diagram schematically illustrating a correlation curve calculated by applying a high-pass filter and a correlation curve calculated by applying a low-pass filter,

FIG. 22 is a flowchart illustrating reliability determination processing according to a second modification example,

FIG. 23 is a diagram illustrating correlation calculation processing used in high-frequency block determination processing,

FIG. 24 is a flowchart illustrating a flow of high-frequency block determination processing,

FIG. 25 is a diagram illustrating an example of a correlation curve in a case where contrast is low,

FIG. 26 is a flowchart illustrating reliability determination processing according to a third modification example,

FIG. 27 is a diagram illustrating a defective block,

FIG. 28 is a flowchart illustrating reliability determination processing according to a fourth modification example,

FIG. 29 is a flowchart illustrating median value selection processing according to a fifth modification example, and

FIG. 30 is a diagram illustrating a nearest value.

### DETAILED DESCRIPTION

An example of an embodiment according to the technology of the present disclosure will be described with reference to the accompanying drawings.

First, the terms used in the following description will be described.

In the following description, “IC” is an abbreviation for “integrated circuit”. “CPU” is an abbreviation for “central processing unit”. “ROM” is an abbreviation for “read only memory”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”. “CNN” is an abbreviation for “convolutional neural network”. “AF” is an abbreviation of “auto focus”.

As one embodiment of an imaging apparatus, the technology of the present disclosure will be described by using a lens-interchangeable digital camera as an example. Note that the technology of the present disclosure is not limited to the lens-interchangeable type and can also be applied to a lens-integrated digital camera.

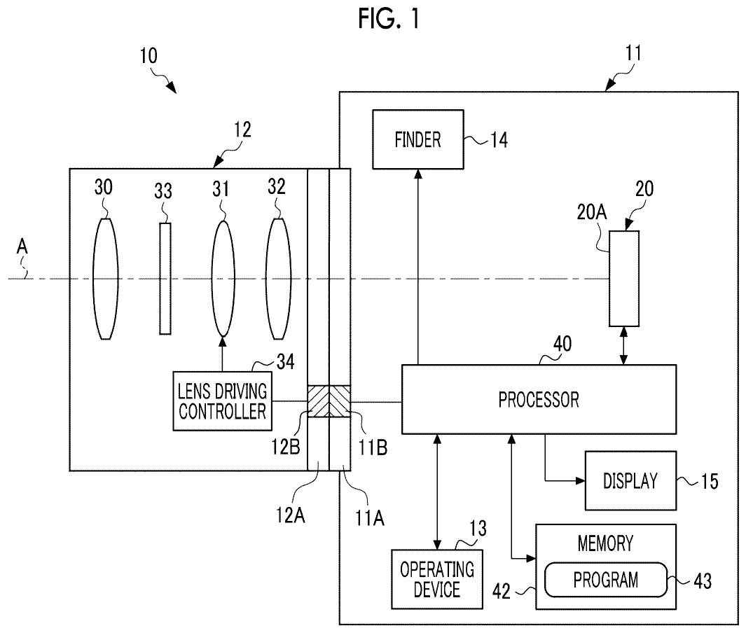

FIG. 1 illustrates an example of a configuration of an imaging apparatus 10. The imaging apparatus 10 is a lens-interchangeable digital camera. The imaging apparatus 10 includes a body 11 and an imaging lens 12 interchangeably mounted on the body 11. The imaging lens 12 is attached to a front surface side of the body 11 via a camera side mount 11A and a lens side mount 12A.

The body 11 is provided with an operating device 13 that includes a dial, a release button, a touch panel, and the like and receives an operation by a user. Examples of an operation mode of the imaging apparatus 10 include a still image capturing mode, a video capturing mode, and an image display mode. The operating device 13 is operated by the user in a case of setting the operation mode. In addition, the operating device 13 is operated by the user in a case of starting an execution of still image capturing or video capturing. Further, the operating device 13 is operated by the user in a case where an AF area, which is a focusing target, is designated from an imaging region.

Further, the body 11 is provided with a finder 14. Here, the finder 14 is a Hybrid Finder (registered trademark). The Hybrid Finder refers to, for example, a finder in which an optical view finder (hereinafter, referred to as “OVF”) and an electronic view finder (hereinafter, referred to as “EVF”) are selectively used. The user can observe an optical image or a live view image of a subject projected onto the finder 14 via a finder eyepiece portion (not illustrated).

In addition, a display 15 is provided on a rear surface side of the body 11. The display 15 displays an image based on an image signal obtained through imaging, various menu screens, and the like. The user can also observe the live view image projected onto the display 15 instead of the finder 14.

The body 11 and the imaging lens 12 are electrically connected to each other through contact between an electrical contact 11B provided on the camera side mount 11A and an electrical contact 12B provided on the lens side mount 12A.

The imaging lens 12 includes an objective lens 30, a focus lens 31, a rear end lens 32, and a stop 33. Respective members are arranged in the order of the objective lens 30, the stop 33, the focus lens 31, and the rear end lens 32 from an objective side along an optical axis A of the imaging lens 12. The objective lens 30, the focus lens 31, and the rear end lens 32 constitute an imaging optical system. The type, number, and arrangement order of the lenses constituting the imaging optical system are not limited to the example illustrated in FIG. 1.

In addition, the imaging lens 12 includes a lens driving controller 34. The lens driving controller 34 includes, for example, a CPU, a RAM, a ROM, and the like. The lens driving controller 34 is electrically connected to a processor 40 inside the body 11 via the electrical contact 12B and the electrical contact 11B.

The lens driving controller 34 drives the focus lens 31 and the stop 33 based on a control signal transmitted from the processor 40. The lens driving controller 34 performs driving control of the focus lens 31 based on a control signal for focus control that is transmitted from the processor 40, in order to adjust a focusing position of the imaging lens 12. The processor 40 performs focusing position detection using a phase difference method.

The stop 33 has an opening in which an opening diameter is variable with the optical axis A as a center. The lens driving controller 34 performs driving control of the stop 33 based on a control signal for stop adjustment that is transmitted from the processor 40, in order to adjust an amount of light incident on a light-receiving surface 20A of an imaging sensor 20.

Further, the imaging sensor 20, the processor 40, and a memory 42 are provided inside the body 11. The operations of the imaging sensor 20, the memory 42, the operating device 13, the finder 14, and the display 15 are controlled by the processor 40.

The processor 40 is configured by, for example, a CPU. In this case, the processor 40 executes various types of processing based on a program 43 stored in the memory 42. Note that the processor 40 may be configured by an assembly of a plurality of IC chips. The processor 40 and the memory 42 constitute a focus control device.

The imaging sensor 20 is, for example, a CMOS-type image sensor. The imaging sensor 20 is disposed such that the optical axis A is orthogonal to the light-receiving surface 20A and the optical axis A is located at the center of the light-receiving surface 20A. Light passing through the imaging lens 12 is incident on the light-receiving surface 20A. A plurality of pixels for generating signals through photoelectric conversion are formed on the light-receiving surface 20A. The imaging sensor 20 generates and outputs an image signal D by photoelectrically converting the light incident on each pixel. Note that the imaging sensor 20 is an example of an “imaging element” according to the technology of the present disclosure.

In addition, a color filter array of a Bayer array is disposed on the light-receiving surface 20A of the imaging sensor 20, and a color filter of any one of red (R), green (G), or blue (B) is disposed to face each pixel. Note that some of the plurality of pixels arranged on the light-receiving surface 20A of the imaging sensor 20 may be phase difference detection pixels for detecting a phase difference related to focus control.

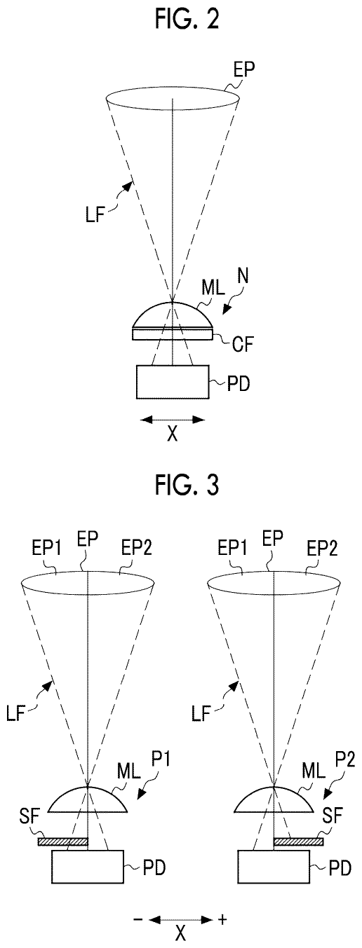

FIG. 2 illustrates an example of a configuration of an imaging pixel N. FIG. 3 illustrates an example of configurations of phase difference detection pixels P1 and P2. Each of the phase difference detection pixels P1 and P2 receives one of rays of luminous flux split in an X direction with a main light ray as the center. Hereinafter, a direction orthogonal to the X direction will be referred to as a Y direction. In addition, the X direction corresponds to a horizontal direction, and the Y direction corresponds to a vertical direction. The phase difference detection pixels P1 and P2 are an example of a “pixel” according to the technology of the present disclosure.

As illustrated in FIG. 2, the imaging pixel N includes a photodiode PD serving as a photoelectric conversion element, a color filter CF, and a microlens ML. The color filter CF is disposed between the photodiode PD and the microlens ML.

The color filter CF is a filter that transmits light of any of R, G, or B. The microlens ML converges a luminous flux LF incident from an exit pupil EP of the imaging lens 12 to substantially the center of the photodiode PD via the color filter CF.

As illustrated in FIG. 3, each of the phase difference detection pixels P1 and P2 includes a photodiode PD, a light shielding layer SF, and a microlens ML. The microlens ML converges, similarly to the imaging pixel N, the luminous flux LF incident from the exit pupil EP of the imaging lens 12 to substantially the center of the photodiode PD.

The light shielding layer SF is formed of a metal film or the like and is disposed between the photodiode PD and the microlens ML. The light shielding layer SF blocks a part of the luminous flux LF incident on the photodiode PD via the microlens ML.

In the phase difference detection pixel P1, the light shielding layer SF blocks light on a negative side in the X direction with the center of the photodiode PD as a reference. That is, in the phase difference detection pixel P1, the light shielding layer SF makes the luminous flux LF from a negative side exit pupil EP1 incident on the photodiode PD, and blocks the luminous flux LF from a positive side exit pupil EP2 in the X direction.

In the phase difference detection pixel P2, the light shielding layer SF blocks light on a positive side in the X direction with the center of the photodiode PD as a reference. That is, in the phase difference detection pixel P2, the light shielding layer SF makes the luminous flux LF from the positive side exit pupil EP2 incident on the photodiode PD, and blocks the luminous flux LF from the negative side exit pupil EP1 in the X direction.

That is, the phase difference detection pixel P1 and the phase difference detection pixel P2 have mutually different light shielding positions in the X direction. A phase difference detection direction of the phase difference detection pixels P1 and P2 is the X direction (that is, the horizontal direction).

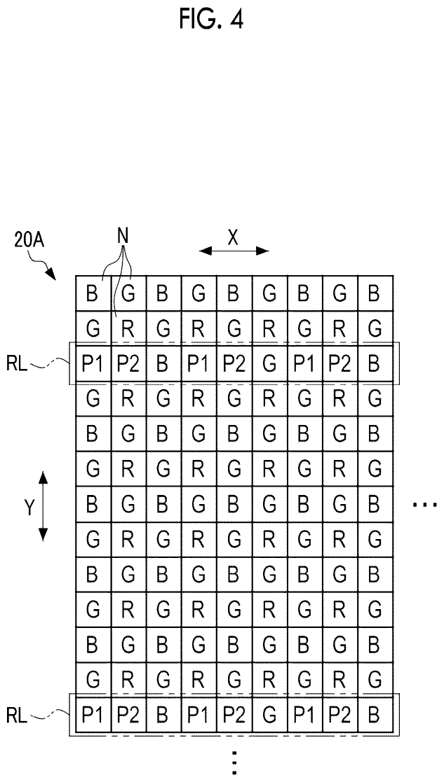

FIG. 4 illustrates an example of pixel arrangement of the imaging sensor 20. “R” in FIG. 4 indicates the imaging pixel N provided with the color filter CF of R. “G” indicates the imaging pixel N provided with the color filter CF of G. “B” indicates the imaging pixel N provided with the color filter CF of B. Note that the color arrangement of the color filter CF is not limited to the Bayer array and may be another color arrangement.

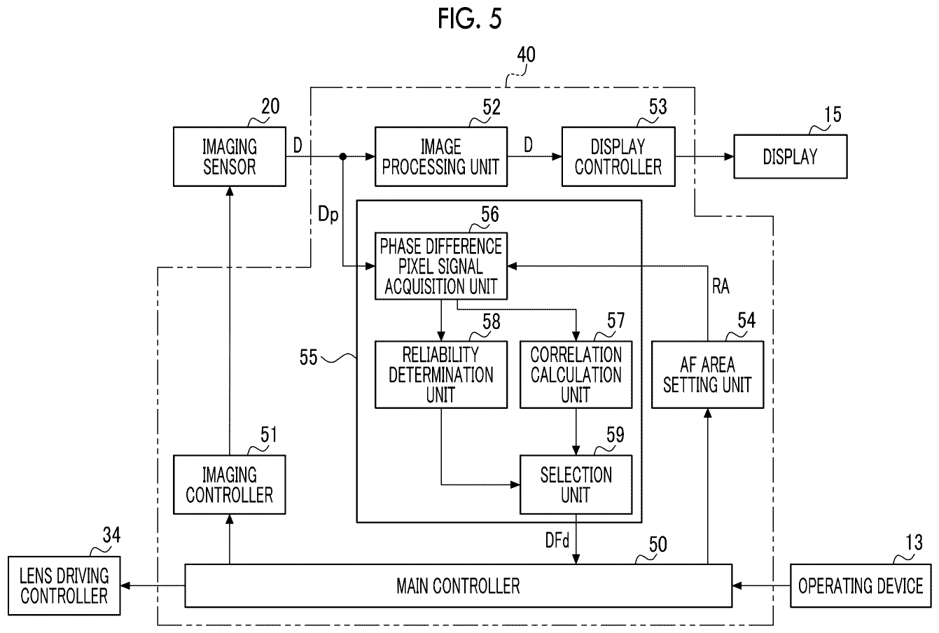

Rows RL including the phase difference detection pixels P1 and P2 are arranged every 10 pixels in the Y direction. In each row RL, a pair of phase difference detection pixels P1 and P2 and one imaging pixel N are repeatedly arranged in the Y direction. Note that an arrangement pattern of the phase difference detection pixels P1 and P2 is not limited to the example illustrated in FIG. 4. For example, a pattern in which a plurality of phase difference detection pixels are disposed in one microlens ML as illustrated in FIG. 5 attached to JP2018-56703A may be used.

FIG. 5 illustrates an example of a functional configuration of the processor 40. The processor 40 implements various functional units by executing processing in accordance with the program 43 stored in the memory 42. As illustrated in FIG. 5, for example, the processor 40 implements a main controller 50, an imaging controller 51, an image processing unit 52, a display controller 53, an AF area setting unit 54, and a driving defocus amount acquisition unit 55.

The main controller 50 comprehensively controls the operation of the imaging apparatus 10 based on output information from the operating device 13. The imaging controller 51 executes imaging processing of causing the imaging sensor 20 to perform an imaging operation by controlling the imaging sensor 20. The imaging controller 51 drives the imaging sensor 20 in the still image capturing mode or the video capturing mode.

The imaging sensor 20 outputs an image signal D including an imaging signal generated by the imaging pixels N and a phase difference pixel signal generated by the phase difference detection pixels P1 and P2.

The image processing unit 52 acquires the image signal D output from the imaging sensor 20, and performs image processing such as demosaicing on the acquired image signal D.

The display controller 53 causes the display 15 to display an image represented by the image signal D obtained by performing the image processing by the image processing unit 52. In addition, the display controller 53 causes the display 15 to perform live view image display based on the image signal D that is periodically input from the image processing unit 52 during an imaging preparation operation before the still image capturing or the video capturing. Further, the display controller 53 displays an AF area RA and the like designated by the user using the operating device 13 on the display 15. For example, the operating device 13 is a touch panel provided on a display surface of the display 15, and the user can designate the AF area RA by touching the touch panel with a finger.

The AF area setting unit 54 sets a rectangular AF area RA in the imaging region based on output information from the operating device 13. In the present embodiment, the AF area setting unit 54 divides the AF area RA into a plurality of small areas SA. Setting information of the AF area RA is input to the driving defocus amount acquisition unit 55. The plurality of small areas SA are an example of “a plurality of areas set in an imaging region” according to the technology of the present disclosure.

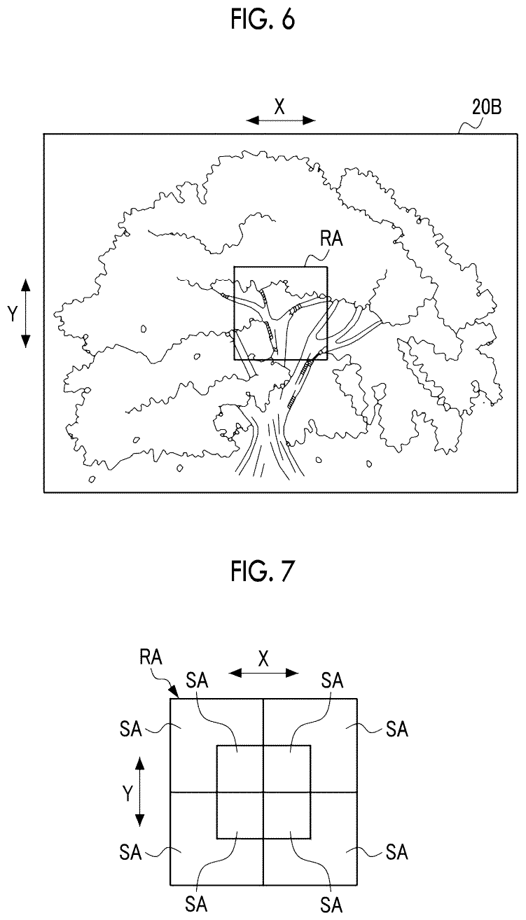

FIG. 6 illustrates an example of the AF area RA. The user can designate the AF area RA in the imaging region 20B of the imaging sensor 20 by operating the operating device 13. In addition, the user can designate a size, a position, and the like of the AF area RA by operating the operating device 13.

FIG. 7 illustrates an example of the plurality of small areas SA. In the example illustrated in FIG. 7, the AF area RA is divided into eight small areas SA. Further, each of the small areas SA is divided into a plurality of blocks BL. The number, a shape, a size, and the like of each small area SA are not limited to the example illustrated in FIG. 7, and can be appropriately changed. In addition, the plurality of small areas SA may be spaced from each other.

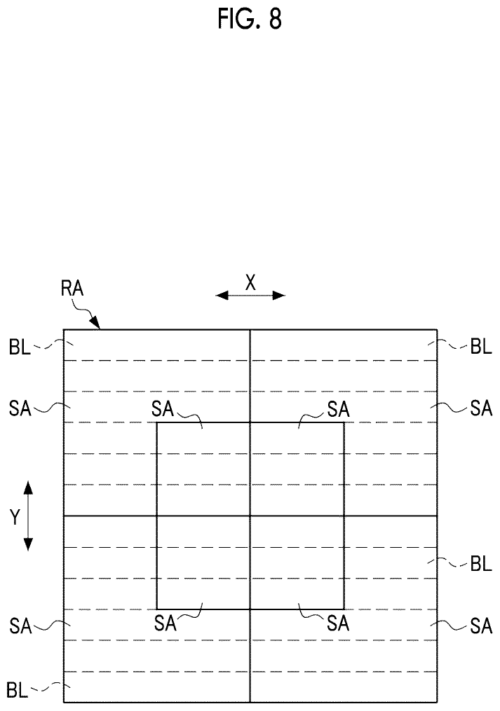

FIG. 8 illustrates an example of the plurality of blocks BL. In the example illustrated in FIG. 8, each of the blocks BL is a rectangular area extending in the X direction. Each of the blocks BL includes at least one row RL (refer to FIG. 4).

Returning to FIG. 5, the driving defocus amount acquisition unit 55 includes a phase difference pixel signal acquisition unit 56, a correlation calculation unit 57, a reliability determination unit 58, and a selection unit 59. The phase difference pixel signal acquisition unit 56 acquires phase difference pixel signals Dp in the AF area RA from the image signal D output from the imaging sensor 20. The phase difference pixel signals Dp are pixel values of the phase difference detection pixels P1 and P2.

The correlation calculation unit 57 calculates a defocus amount for each block BL by performing correlation calculation based on the phase difference detection pixels P1 and P2 for each block BL.

The reliability determination unit 58 determines a reliability of each defocus amount calculated by the correlation calculation unit 57. In a case where the image signal D includes a signal that affects a decrease in the reliability, specifically, a signal that exceeds the limit of the performance (a resolution, a sensitivity, a saturation, an S/N ratio, and the like) of the imaging sensor 20, the reliability of the defocus amount is decreased. In the present embodiment, the reliability determination unit 58 determines the reliability of the defocus amount based on the saturations of the phase difference detection pixels P1 and P2. That is, in the present embodiment, the reliability is related to the saturations of the phase difference detection pixels P1 and P2, and a signal exceeding a saturation upper limit is a signal that affects a decrease in the reliability.

The selection unit 59 selects one of the plurality of defocus amounts calculated by the correlation calculation unit 57 based on the reliability determined by the reliability determination unit 58, as a driving defocus amount DFd for driving the focus lens 31.

The driving defocus amount acquisition unit 55 outputs the driving defocus amount DFd selected by the selection unit 59. The driving defocus amount DFd is an example of a “defocus amount for driving the focus lens” according to the technology of the present disclosure.

The main controller 50 adjusts the focusing position by driving the focus lens 31 via the lens driving controller 34 based on the driving defocus amount DFd output from the driving defocus amount acquisition unit 55. Thereby, the subject in the AF area RA is in a focused state.

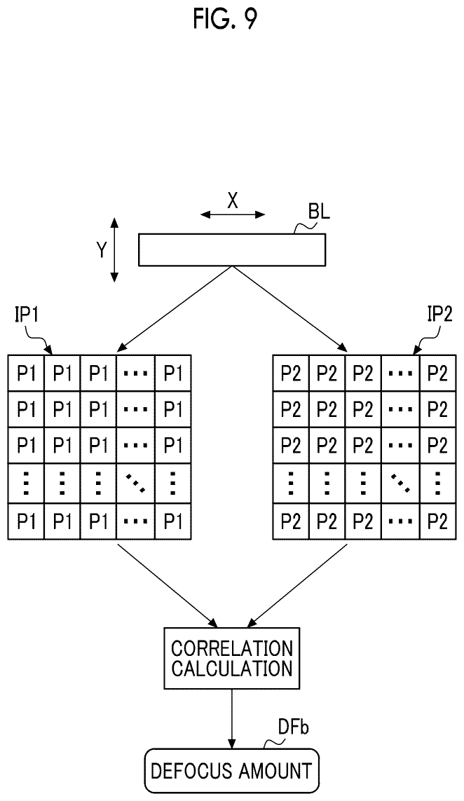

FIG. 9 illustrates an example of correlation calculation processing. The correlation calculation unit 57 calculates the defocus amount DFb by performing correlation calculation using a first image IP1 including signals of a plurality of phase difference detection pixels P1 and a second image IP2 including signals of a plurality of phase difference detection pixels P2, the phase difference detection pixels P1 and P2 being included in the block BL. The defocus amount DFb is a defocus amount calculated from one block BL.

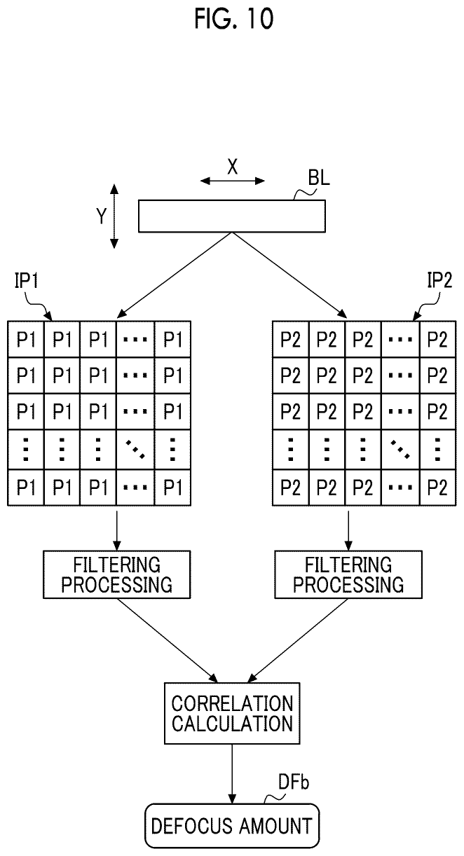

FIG. 10 illustrates an example of the correlation calculation processing including filtering processing. The correlation calculation unit 57 may calculate the defocus amount DFb by performing correlation calculation using an image obtained by performing filtering processing on the first image IP1 and an image obtained by performing filtering processing on the second image IP2. The same filtering processing is performed on the first image IP1 and the second image IP2.

The correlation calculation unit 57 may acquire a plurality of defocus amounts DFb from each of the blocks BL by calculating the defocus amount DFb without performing filtering processing as illustrated in FIG. 9 and calculating the defocus amount DFb by performing filtering processing as illustrated in FIG. 10. Further, the correlation calculation unit 57 may calculate three or more defocus amounts DFb from each of the blocks BL by performing a plurality of pieces of filtering processing in which frequency characteristics such as a cutoff frequency are different.

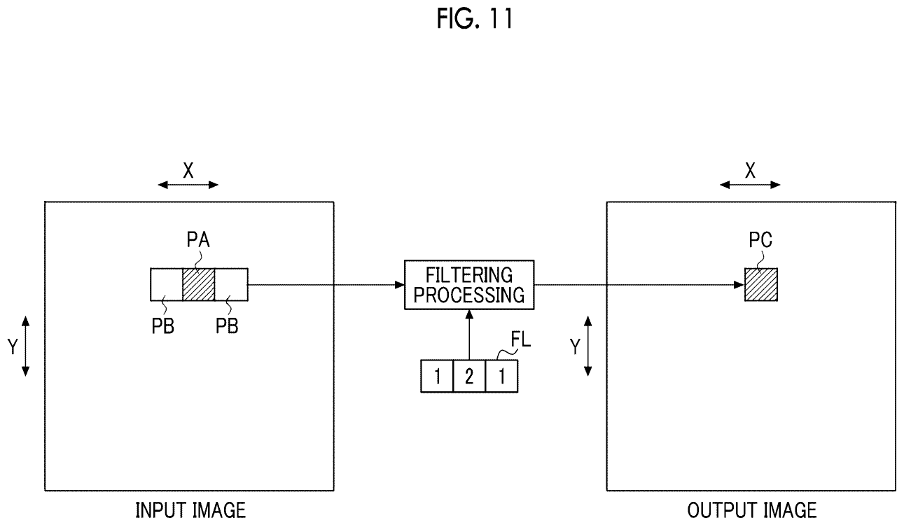

FIG. 11 illustrates an example of filtering processing. The correlation calculation unit 57 performs filtering processing using a one-dimensional filter FL in which weight coefficients are arranged in the X direction that is a phase difference detection direction. Specifically, a value obtained by performing weight addition of a pixel value of a conversion pixel PA in the input image and a pixel value of an adjacent pixel PB adjacent to the conversion pixel PA by a weight coefficient defined by the filter FL is used as a pixel value of the converted pixel PC in the output image. The output image is generated by performing filtering processing using, as the conversion pixels PA, all the pixels in the input image.

The filter FL is also referred to as a kernel. In the example illustrated in FIG. 11, the filter FL is a kernel of 3×1 pixels. On the other hand, the filter FL may be a kernel of 5×1 pixels or the like. As the filter FL, a kernel such as “121” or “12221” may be used. Note that the filtering processing illustrated in FIG. 11 is so-called convolution processing. The input image is the first image IP1 or the second image IP2 described above.

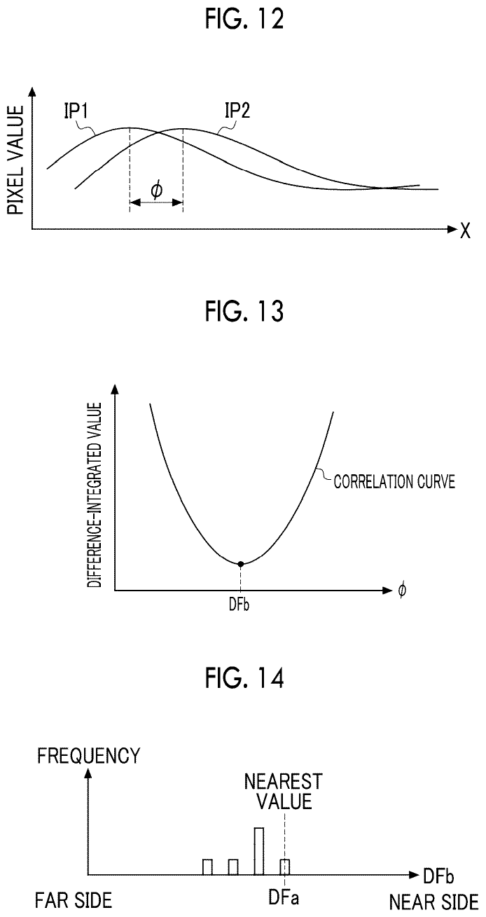

FIG. 12 illustrates details of the correlation calculation processing. For simplification of the description, in FIG. 12, the first image IP1 and the second image IP2 are illustrated as one-dimensional waveforms in the X direction. As a method of obtaining a correlation amount between the image IP1 and the second image IP2, a known method can be adopted. For example, an integrated value (hereinafter, referred to as a “difference-integrated value”) of an absolute value of a difference between each point IP1 (X, Y) of the image IP1 and each point IP2 (X+φ, Y) of the second image IP2 is calculated.

FIG. 13 illustrates an example of a correlation curve representing a relationship between a correlation amount and a phase difference φ of the image IP1 and the second image IP2. Specifically, FIG. 13 is a correlation curve representing a relationship between the difference-integrated value and the phase difference φ. The correlation calculation unit 57 calculates a phase difference φ at which the difference-integrated value is a minimum (that is, the correlation amount is a maximum) as the defocus amount DFb.

FIG. 14 to FIG. 16 describe selection processing by the selection unit 59. The selection processing includes first selection processing and second selection processing. In the first selection processing, the selection unit 59 selects one of the plurality of defocus amounts DFb calculated for one small area SA, and sets the selected defocus amount as a defocus amount DFa. In the second selection processing, the selection unit 59 selects one of the plurality of defocus amounts DFa acquired for each small area SA based on the reliability determined by the reliability determination unit 58, and sets the selected defocus amount as the driving defocus amount DFd.

FIG. 14 illustrates an example of the first selection processing. FIG. 14 is a graph showing a frequency distribution of the defocus amounts DFb. A plurality of blocks BL are included in one small area SA, and one or more defocus amounts DFb are calculated from one block BL. Thereby, a plurality of defocus amounts DFb are calculated from one small area SA. Therefore, in the first selection processing, the selection unit 59 selects, for example, a nearest value of the plurality of defocus amounts DFb calculated from one small area SA, as the defocus amount DFa. The nearest value is a value nearest to the NEAR side (that is, a rearmost pin side). Note that, in the first selection processing, the selection unit 59 may select a median value, an average value, or the like, as the defocus amount DFa, without being limited to the nearest value of the plurality of defocus amounts DFb.

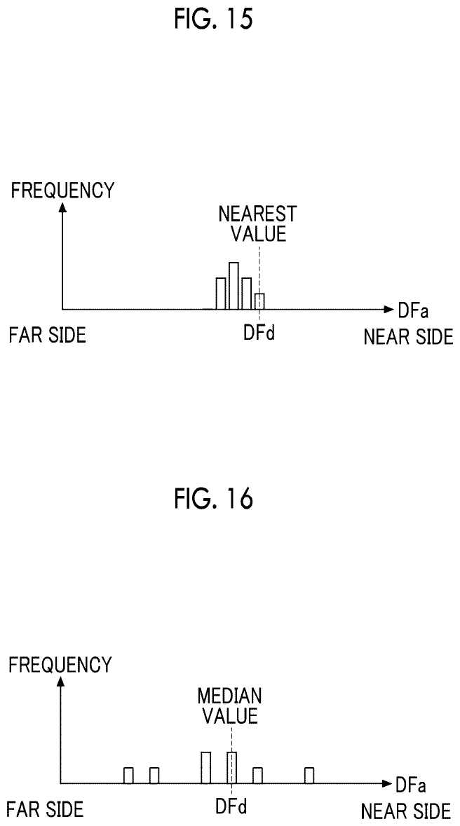

FIG. 15 and FIG. 16 illustrate an example of the second selection processing. FIG. 15 and FIG. 16 are graphs showing a frequency distribution of the defocus amounts DFa. Since the plurality of small areas SA are included in the AF area RA, a plurality of defocus amounts DFa are calculated from the AF area RA. In a situation where the scenery is backlight, the AF area RA may include a point light source such as light incident from a gap between branches of a tree. In such a manner, in a case where a point light source is included in the AF area RA, although the correlation curve (refer to FIG. 13) appears to be normal at first glance, the reliability of the defocus amount DFa calculated from the small area SA including the point light source is low. In a case where the reliabilities of the plurality of defocus amounts DFa are high, it is preferable to select the nearest value such that the subject nearest to the front side is in focus. On the other hand, in a case where the reliabilities are low, it is preferable to select the median value.

In the second selection processing, the selection unit 59 selects the nearest value or the median value of the plurality of defocus amounts DFa, as the driving defocus amount DFd, based on the determination result of the reliability for each small area SA by the reliability determination unit 58. FIG. 15 illustrates an example in which the nearest value is selected as the driving defocus amount DFd in a case where the reliability is high. FIG. 16 illustrates an example in which the median value is selected as the driving defocus amount DFd in a case where the reliability is low.

Note that the nearest value is a defocus amount representing a distance to the subject on the frontmost side in the AF area RA. In addition, the median value is an example of an “index related to a plurality of defocus amounts”, and more specifically, the median value is an example of an “index based on frequencies of the plurality of defocus amounts”.

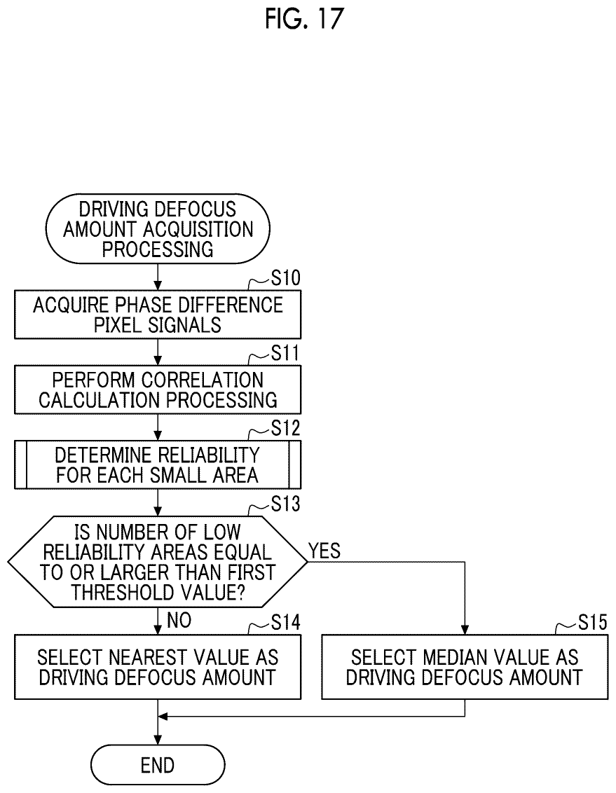

FIG. 17 illustrates a flow of the driving defocus amount acquisition processing by the driving defocus amount acquisition unit 55. In the driving defocus amount acquisition processing, first, the phase difference pixel signal acquisition unit 56 acquires the phase difference pixel signals Dp in the AF area RA (step S10). Next, the correlation calculation unit 57 calculates a defocus amount DFa for each small area SA by performing the correlation calculation processing (step S11).

Next, the reliability determination unit 58 determines the reliability for each small area SA (step S12). As will be described in detail later, the reliability determination unit 58 determines the reliability of the defocus amount DFa calculated for each small area SA based on the saturations of the phase difference detection pixels P1 and P2, and sets the small area SA having a low reliability as a low reliability area.

Next, the selection unit 59 determines whether or not the number of the low reliability areas is equal to or larger than a first threshold value (step S13). The first threshold value is an integer equal to or larger than 1 and equal to or smaller than the number (8 in the present embodiment) of the small areas SA. For example, the first threshold value is 1. In a case where the number of the low reliability areas is smaller than the first threshold value (NO in step S13), the selection unit 59 selects a nearest value of the plurality of defocus amounts DFa, as the driving defocus amount DFd (step S14). On the other hand, in a case where the number of the low reliability areas is equal to or larger than the first threshold value (YES in step S13), the selection unit 59 selects a median value of the plurality of defocus amounts DFa, as the driving defocus amount DFd (step S15).

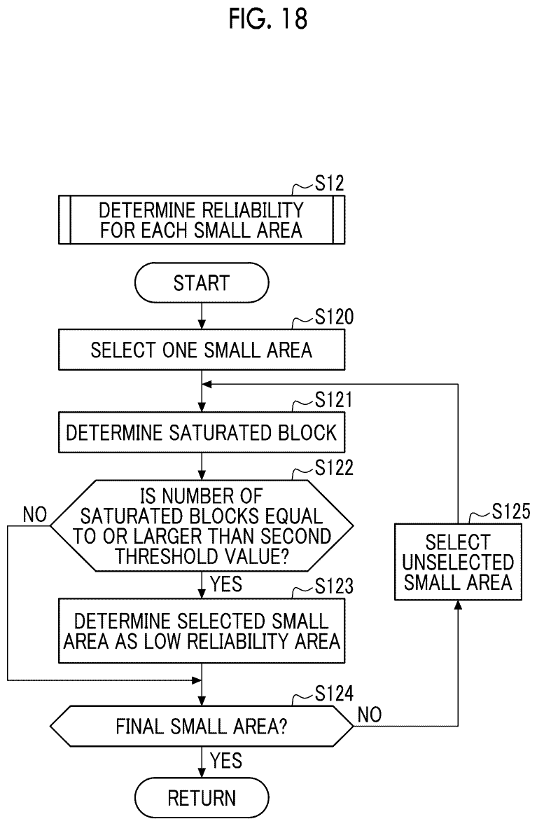

FIG. 18 illustrates an example of the reliability determination processing (step S12) by the reliability determination unit 58. In the reliability determination processing, first, one small area SA is selected from the plurality of small areas SA included in the AF area RA (step S120).

Next, the reliability determination unit 58 determines whether or not each of the blocks BL included in the selected small area SA is a saturated block (step S121). The saturated block is a block BL including saturated pixels (in the present embodiment, the phase difference detection pixels P1 or the phase difference detection pixels P2) in which the pixel value is the maximum value or is equal to or larger than a predetermined threshold value. In a case where the number of the saturated pixels included in the block BL is equal to or larger than N, the reliability determination unit 58 determines the block BL as a saturated block. N is an integer equal to or larger than 1. That is, the reliability determination unit 58 determines whether or not the block BL is a saturated block based on a content rate of a signal (in the present embodiment, a saturated pixel signal) that affects a decrease in the reliability. The saturated block is an example of a “defective block” according to the technology of the present disclosure.

The reliability determination unit 58 determines whether or not the number of the saturated blocks included in the selected small area SA is equal to or larger than a second threshold value (step S122). The second threshold value is an integer equal to or larger than 1 and equal to or smaller than the number of the blocks BL included in the small area SA. For example, the second threshold value is 1.

In a case where the number of the saturated blocks is equal to or larger than the second threshold value (YES in step S122), the reliability determination unit 58 determines the selected small area SA as the low reliability area (step S123). In a case where the number of the saturated blocks is smaller than the second threshold value (NO in step S122), the reliability determination unit 58 advances the processing to step S124.

After step S122 or step S123, the reliability determination unit 58 determines whether or not the selected small area SA is the final small area SA (step S124). In a case where the selected small area SA is not the final small area SA (NO in step S124), the reliability determination unit 58 selects an unselected small area SA (step S125), and returns the processing to step S121.

The reliability determination unit 58 repeatedly executes the processing of step S121 to step S125 until it is determined that the selected small area SA is the final small area SA. In a case where the selected small area SA is the final small area SA (YES in step S124), the reliability determination unit 58 ends the processing. By the reliability determination processing described above, the number of the low reliability areas included in the AF area RA is obtained.

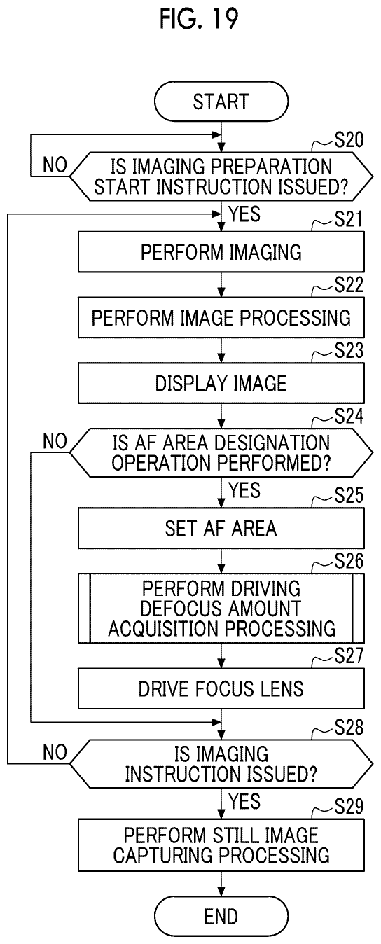

FIG. 19 illustrates an example of a flow of overall processing executed by the imaging apparatus 10. First, the main controller 50 determines whether or not an imaging preparation start instruction is issued by the user operating the operating device 13 (step S20). In a case where an imaging preparation start instruction is issued (YES in step S20), the main controller 50 controls the imaging controller 51 to cause the imaging sensor 20 to perform an imaging operation (step S21).

The image processing unit 52 acquires the image signal D output from the imaging sensor 20, and performs the image processing on the image signal D (step S22). The display controller 53 causes the display 15 to display the image represented by the image signal D obtained by performing the image processing (step S23).

Next, the main controller 50 determines whether or not the user performs an operation of designating an AF area RA using the operating device 13 (hereinafter, referred to as an “AF area designation operation”) (step S24). In a case where an AF area designation operation is not performed (NO in step S24), the main controller 50 advances the processing to step S28.

In a case where an AF area designation operation is performed (YES in step S24), the AF area setting unit 54 sets an AF area RA in the imaging region based on output information from the operating device 13 (step S25).

Next, the driving defocus amount acquisition unit 55 acquires a driving defocus amount DFd by executing the driving defocus amount acquisition processing (refer to FIG. 17 and FIG. 18) described above (step S26). The main controller 50 drives the focus lens 31 based on the acquired driving defocus amount DFd (step S27).

After step S24 or step S27, the main controller 50 determines whether or not an imaging instruction is issued by the user operating the operating device 13 (step S28). In a case where an operation instruction is not issued (NO in step S28), the main controller 50 returns the processing to step S21. The processing of step S21 to step S28 is repeatedly executed until the main controller 50 determines that an imaging instruction is issued in step S28.

In a case where an imaging instruction is issued (YES in step S28), the main controller 50 causes the imaging sensor 20 to perform an imaging operation, and performs still image capturing processing of recording, as a still image, the image signal D obtained by performing image processing by the image processing unit 52 in the memory 42 (step S29). With the operations, the processing is ended.

Normally, it is preferable to focus on the subject on the frontmost side among the subjects present in the AF area RA. However, in a situation where backlight scenery is imaged, the AF area RA may include the point light source described above. In such a case, the reliability of the defocus amount DFa obtained from the small area SA including at least the point light source is lowered, and a variation in the distribution of the defocus amount DFa is increased as illustrated in FIG. 16. In addition, even in a case where a plurality of subjects having a large difference in distance are mixed in the AF area RA, a variation in the distribution of the defocus amount DFa is increased. In a state where a variation in the distribution is large in this way, in a case where the nearest value is set as the driving defocus amount DFd, it is unclear whether or not the subject on the frontmost side is in focus, and the focusing accuracy is lowered. For example, in a case where the defocus amount DFa having a low reliability due to the point light source is set as the nearest value, an out-of-focus state is obtained.

In the technology of the present disclosure, the number of the low reliability areas in which the reliability of the defocus amount DFa is low is obtained for each of the plurality of small areas SA, and in a case where the number of the low reliability areas is equal to or larger than a first threshold value, the median value of the plurality of defocus amounts DFa is set as the driving defocus amount DFd. Therefore, according to the technology of the present disclosure, in a situation where a variation in the distribution of the defocus amount DFa is large as illustrated in FIG. 16, the median value is set as the driving defocus amount DFd. Therefore, the out-of-focus state as described above is reduced, and the focusing accuracy is improved. In addition, in the technology of the present disclosure, in a case where the number of the low reliability areas is smaller than the first threshold value, the nearest value of the plurality of defocus amounts DFa is set as the driving defocus amount DFd. Therefore, it is possible to prevent the focusing accuracy from being decreased due to selection of the median value in a case where the reliability is high.

Hereinafter, various modification examples of the above-described embodiment will be described.

### First Modification Example

In the embodiment described above, the selection unit 59 selects, in the first selection processing, the nearest value of the plurality of defocus amounts DFb calculated from the small area SA, as the defocus amount DFa, regardless of whether or not the small area SA is the low reliability area (refer to FIG. 14). Instead of this, in a case where the small area SA is not the low reliability area, the selection unit 59 may select the nearest value of the plurality of defocus amounts DFb calculated from the small area SA, as the defocus amount DFa, and in a case where the small area SA is the low reliability area, the selection unit 59 may select the median value of the plurality of defocus amounts DFb calculated from the small area SA, as the defocus amount DFa.

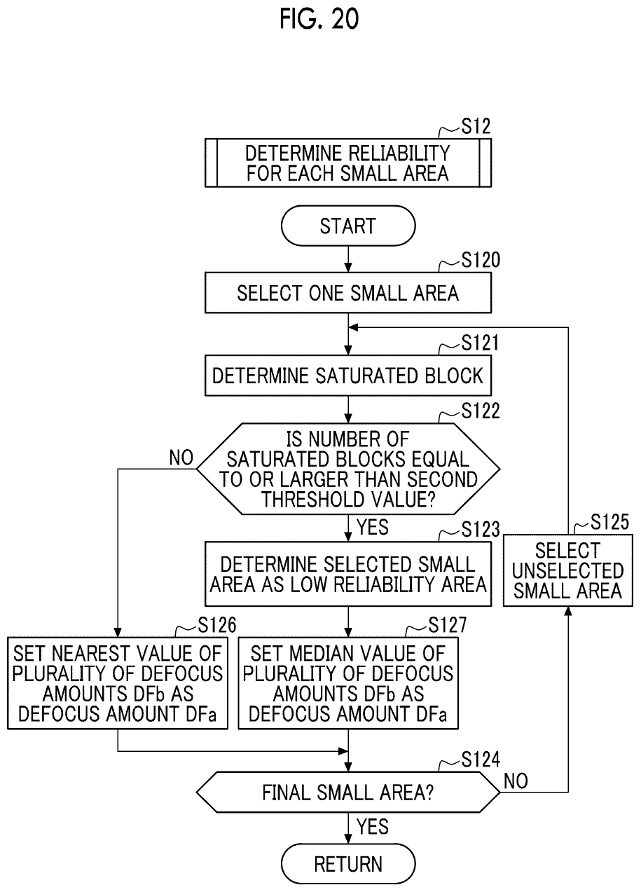

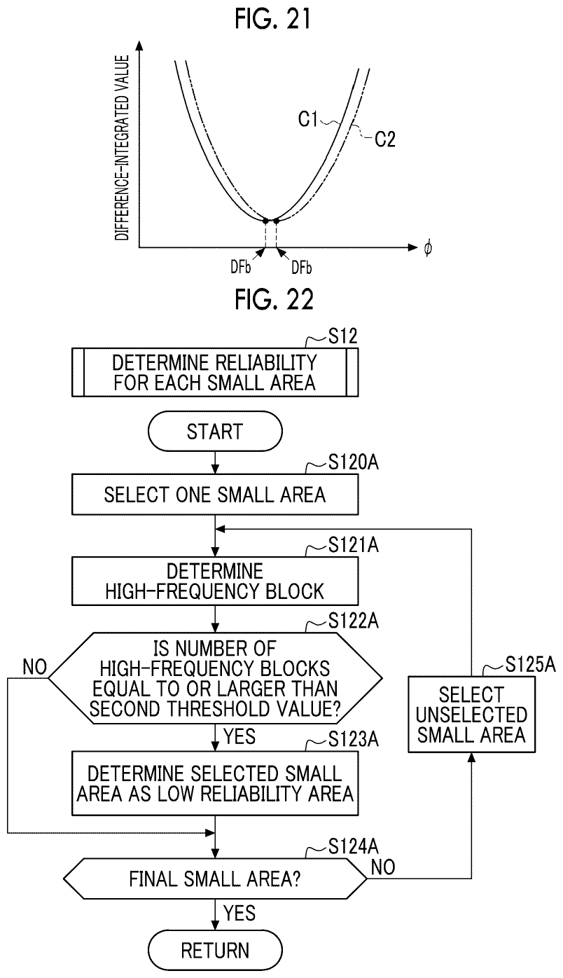

FIG. 20 illustrates reliability determination processing according to the first modification example. The reliability determination processing according to the present modification example is different from the reliability determination processing illustrated in FIG. 18 only in that step S126 and step S127 to be executed by the selection unit 59 are added.

In a case where the number of the saturated blocks is smaller than the second threshold value (NO in step S122), the selection unit 59 sets the nearest value of the plurality of defocus amounts DFb calculated from the selected small area SA, as the defocus amount DFa (step S126). On the other hand, in a case where the number of the saturated blocks is equal to or larger than the second threshold value (YES in step S122), the median value of the plurality of defocus amounts DFb calculated from the selected small area SA (that is, the low reliability area) is set as the defocus amount DFa (step S127). Subsequent processing is the same as that of the above-described embodiment.

Note that the small area SA (that is, the low reliability area) for which it is determined that the number of the saturated blocks is equal to or larger than the second threshold value corresponds to a “first area” according to the technology of the present disclosure. The small area SA for which it is determined that the number of the saturated blocks is smaller than the second threshold value corresponds to a “second area” according to the technology of the present disclosure.

In the present modification example, the defocus amount DFa is set by selecting the nearest value or the median value from the plurality of defocus amounts DFb calculated from the small area SA based on the number of saturated blocks. Therefore, the reliability of the defocus amount DFa for each small area SA is improved. Thereby, the focusing accuracy is further improved.

Note that, in the example illustrated in FIG. 20, the selection unit 59 executes step S126 and step S127 during the execution of the reliability determination processing. On the other hand, the selection unit 59 may execute step S126 and step S127 after the reliability determination processing is completed.

### Second Modification Example

In the embodiment, the reliability is determined based on the saturations of the plurality of phase difference pixels. On the other hand, the present disclosure is not limited thereto. The reliability may be determined based on frequency components included in images (the first image IP1 and the second image IP2) represented by a plurality of pixels. In the present modification example, the reliability is related to frequency components included in the image. In the present modification example, a plurality of pieces of filtering processing having different frequency characteristics are performed on the images, and the reliability is determined based on evaluation values obtained by the plurality of pieces of filtering processing. The reliability is related to frequency components included in the images.

In a case where high-frequency components exceeding the resolution of the imaging sensor 20 are included in the first image IP1 and the second image IP2, the defocus amount DFb calculated by the correlation calculation processing including the filtering processing illustrated in FIG. 10 is different depending on the characteristics of the filter FL to be applied. However, it is difficult to determine which of the defocus amounts DFb is the true value.

FIG. 12 schematically illustrates a correlation curve C1 calculated by applying a high-pass filter as the filter FL and a correlation curve C2 calculated by applying a low-pass filter as the filter FL. For example, the high-pass filter is a kernel having a weight coefficient of “121”, and the low-pass filter is a kernel having a weight coefficient of “12221”. As illustrated in FIG. 12, since there is a deviation between the correlation curve C1 and the correlation curve C2, the defocus amounts DFb obtained from the correlation curve C1 and the correlation curve C2 are different from each other. In general, it seems that the correct defocus amount DFb is calculated for the high-pass filter. However, in a case where high-frequency components exceeding the resolution of the imaging sensor 20 are included, the calculated defocus amount DFb is randomly varied due to a slight difference in angle of view. That is, the reliability of the defocus amount DFa determined from the plurality of defocus amounts DFb is lowered.

In the present modification example, it is determined whether or not the image includes high-frequency components having a certain frequency or higher, that is, whether or not the block BL includes high-frequency components having a certain frequency or higher, based on a difference in the defocus amounts DFb between the two filters FL having different frequency characteristics. Hereinafter, the block BL including high-frequency components having a certain frequency or higher is referred to as a “high-frequency block”. Note that the high-frequency components having a certain frequency or higher are, for example, signals having a resolution exceeding the resolution of the imaging sensor 20. In the present modification example, the reliability determination unit 58 determines whether or not the block BL is a high-frequency block based on the content rate of the signal (in the present embodiment, the high frequency signal) that affects a decrease in the reliability. The high-frequency block is an example of a “defective block” according to the technology of the present disclosure. In addition, in the present modification example, the reliability determination unit 58 performs a plurality of pieces of filtering processing having different frequency characteristics on the images, and determines the reliability based on evaluation values obtained by the plurality of pieces of filtering processing.

FIG. 22 illustrates reliability determination processing according to the second modification example. In step S120A to step S125A illustrated in FIG. 22, only step S121A and step S122A are different from step S120 to step S125 illustrated in FIG. 18. In step S121A, the reliability determination unit 58 determines whether or not each of the blocks BL included in the selected small area SA is a high-frequency block. In step S122A, the reliability determination unit 58 determines whether or not the number of the high-frequency blocks included in the selected small area SA is equal to or larger than a second threshold value. Subsequent processing is the same as that of the above-described embodiment.

Note that the same modification as the first modification example illustrated in FIG. 20 may be applied to the reliability determination processing according to the present modification example. That is, the nearest value may be set as the defocus amount DFa in a case where the number of the high-frequency blocks is smaller than the second threshold value, and the median value may be set as the defocus amount DFa in a case where the number of the high-frequency blocks is equal to or larger than the second threshold value.

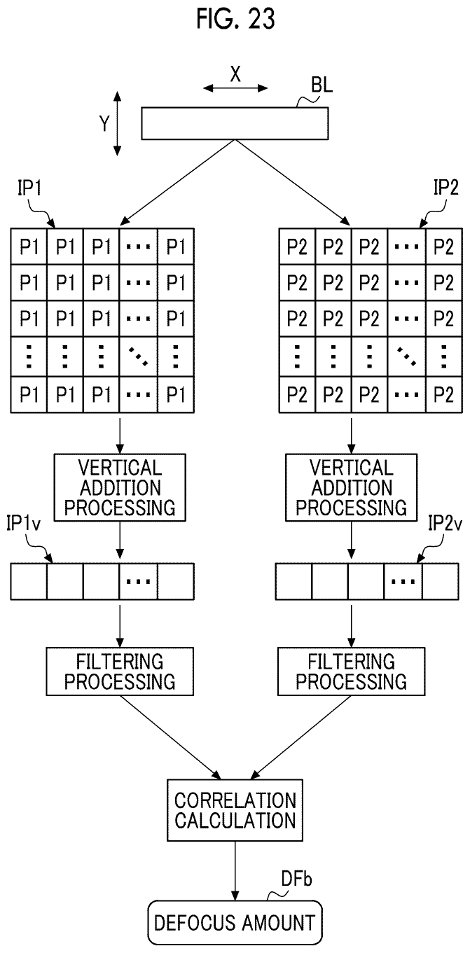

FIG. 23 illustrates correlation calculation processing used in the high-frequency block determination processing (step S121A). In the present modification example, the correlation calculation processing including the filtering processing is performed by using two one-dimensional images, which are obtained by performing vertical addition processing on each of the first image IP1 and the second image IP2, as a criterion for determining a difference in the defocus amounts DFb between two filters FL having different frequency characteristics. Note that the vertical addition processing refers to processing of adding pixel values of a two-dimensional image in the Y direction to obtain a one-dimensional image.

In the present modification example, first, the reliability determination unit 58 calculates the defocus amount DFb by performing correlation calculation based on first two-dimensional images generated by performing the first filtering processing on the two-dimensional images (the first image IP1 and the second image IP2). For example, the first filtering processing is filtering processing in which the high-pass filter is applied as the filter FL. Hereinafter, the defocus amount DFb calculated by the correlation calculation based on the first two-dimensional images is referred to as a “first defocus amount DFb1”.

In addition, the reliability determination unit 58 calculates the defocus amount DFb by performing the correlation calculation based on first one-dimensional images generated by performing the first filtering processing on one-dimensional images (images IP1v and IP2v illustrated in FIG. 23) obtained by performing vertical addition processing on the two-dimensional images (the first image IP1 and the second image IP2). Hereinafter, the defocus amount DFb calculated by the correlation calculation based on the first one-dimensional images is referred to as a “second defocus amount DFb2”.

In addition, the reliability determination unit 58 calculates the defocus amount DFb by performing correlation calculation based on second two-dimensional images generated by performing the second filtering processing on the two-dimensional images (the first image IP1 and the second image IP2). The second filtering processing has different frequency characteristics from the first filtering processing. For example, the second filtering processing is filtering processing in which the low-pass filter is applied as the filter FL. Hereinafter, the defocus amount DFb calculated by the correlation calculation based on the second two-dimensional images is referred to as a “third defocus amount DFb3”.

In addition, the reliability determination unit 58 calculates the defocus amount DFb by performing the correlation calculation based on second one-dimensional images generated by performing the second filtering processing on one-dimensional images (images IP1v and IP2v illustrated in FIG. 23) obtained by performing vertical addition processing on the two-dimensional images (the first image IP1 and the second image IP2). Hereinafter, the defocus amount DFb calculated by the correlation calculation based on the second one-dimensional images is referred to as a “fourth defocus amount DFb4”.

In a case where a difference ΔFL between the first defocus amount DFb1 and the third defocus amount DFb3 is larger than any one of a difference ΔV1 between the first defocus amount DFb1 and the second defocus amount DFb2 and a difference ΔV2 between the third defocus amount DFb3 and the fourth defocus amount DFb4, the reliability determination unit 58 determines that the block BL as a determination target is a high-frequency block. Note that the difference ΔFL, the difference ΔV1, and the difference ΔV2 are all the absolute values of the differences. In addition, the difference ΔFL, the difference ΔV1, and the difference ΔV2 are an example of the evaluation values obtained by the plurality of pieces of filtering processing.

This determination method is based on a property that, in a normal subject, the first to fourth defocus amounts DFb1 to DFb4 converge and are distributed on a normal distribution, but in a subject including a high frequency, the difference ΔFL is larger than any one of the difference ΔV1 and the difference ΔV2.

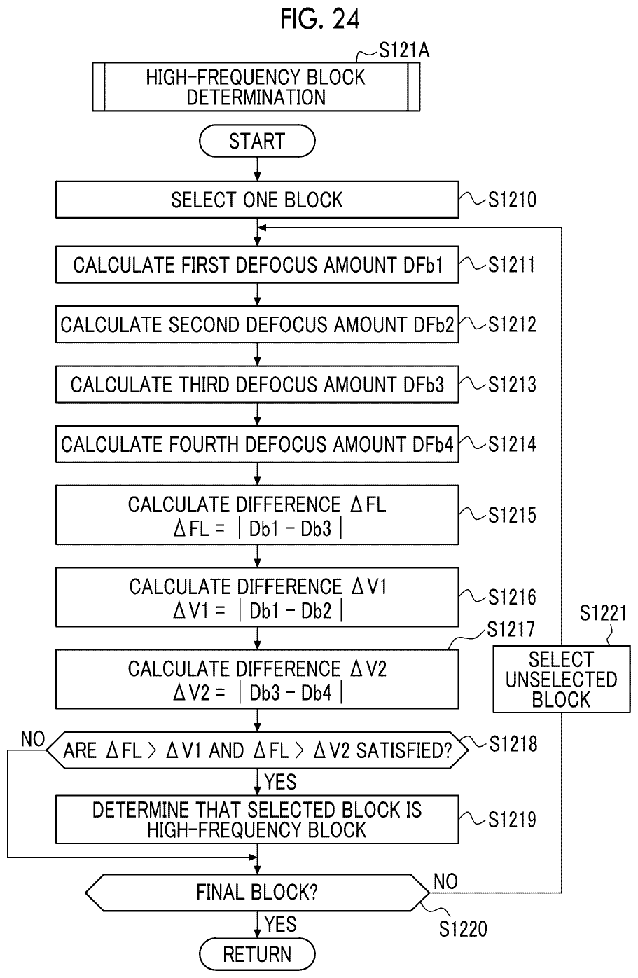

FIG. 24 illustrates a flow of the high-frequency block determination processing (step S121A). First, the reliability determination unit 58 selects one block BL from the plurality of blocks BL included in the small area SA (step S1210).

Next, the reliability determination unit 58 calculates the first defocus amount DFb1 (step S1211), calculates the second defocus amount DFb2 (step S1212), calculates the third defocus amount DFb3 (step S1213), and calculates the fourth defocus amount DFb4 (step S1214) by performing each of the pieces of processing described above based on the two-dimensional images of the selected block BL.

Next, the reliability determination unit 58 calculates the difference ΔFL (step S1215), calculates the difference ΔV1 (step S1216), and calculates the difference ΔV2 (step S1217).

Next, the reliability determination unit 58 determines whether or not ΔFL>ΔV1 and ΔFL>ΔV2 are satisfied (step S1218). In a case where ΔFL>ΔV1 and ΔFL>ΔV2 are satisfied (YES in step S1218), the reliability determination unit 58 determines that the selected block BL is a high-frequency block (step S1219). In a case where ΔFL>ΔV1 and ΔFL>ΔV2 are not satisfied (NO in step S1218), the reliability determination unit 58 advances the processing to step S1220.

After step S1218 or step S1219, the reliability determination unit 58 determines whether or not the selected block BL is the final block BL (step S1220). In a case where the selected block BL is not the final block BL (NO in step S1220), the reliability determination unit 58 selects an unselected block BL (step S1221), and returns the processing to step S1211.

The reliability determination unit 58 repeats the processing of step S1211 to step S1221 until it is determined that the selected block BL is the final block BL. In a case where the selected block BL is the final block BL (YES in step S1220), the reliability determination unit 58 ends the processing. The number of high-frequency blocks is obtained by the above processing.

### Third Modification Example

In the present modification example, the reliability is determined based on the contrast of the images (the first image IP1 and the second image IP2). That is, in the present modification example, the reliability is related to the contrast of the plurality of pixels.

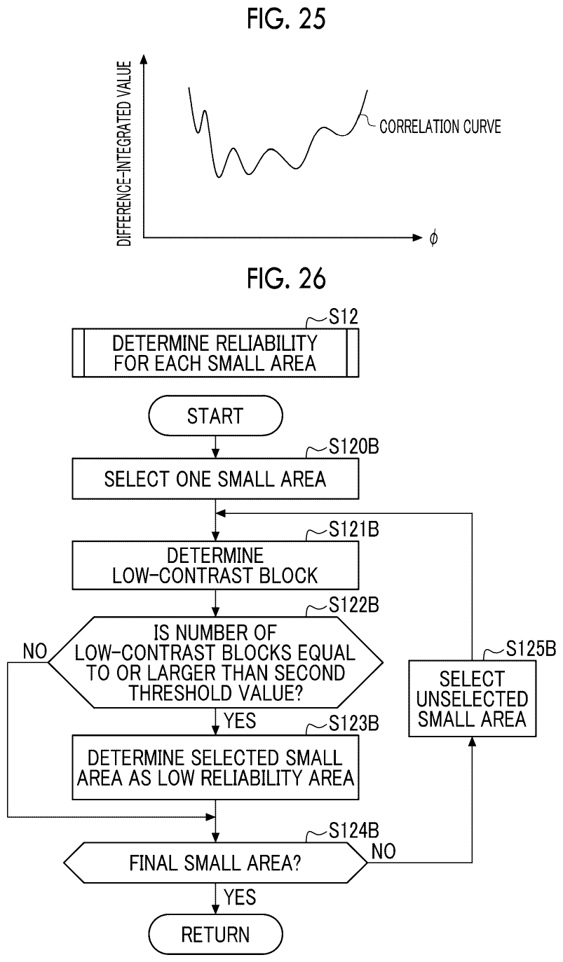

In a case where the contrast is equal to or higher than a certain value, one minimum value appears in the correlation curve as illustrated in FIG. 13, and thus, the reliability of the calculated defocus amount DFb is high. On the other hand, in a case where the contrast is lower than the certain value, a plurality of minimum values may appear in the correlation curve as illustrated in FIG. 25, and thus, the reliability of the calculated defocus amount DFb is low. In the present modification example, a block BL of which contrast is lower than a certain value is referred to as a “low-contrast block”. In the present modification example, the reliability determination unit 58 determines whether or not the block BL is a low-contrast block based on the content rate of a signal (in the present embodiment, a low-contrast signal) that affects a decrease in the reliability. The low-contrast block is an example of a “defective block” according to the technology of the present disclosure. In addition, in the present modification example, the reliability determination unit 58 determines the reliability based on evaluation values related to the contrast.

FIG. 26 illustrates reliability determination processing according to the third modification example. In step S120B to step S125B illustrated in FIG. 26, only step S121B and step S122B are different from step S120 to step S125 illustrated in FIG. 18. In step S121B, the reliability determination unit 58 determines whether or not each of the blocks BL included in the selected small area SA is a low-contrast block. In step S122B, the reliability determination unit 58 determines whether or not the number of the low-contrast blocks included in the selected small area SA is equal to or larger than a second threshold value. Subsequent processing is the same as that of the above-described embodiment.

In the present modification example, in step S121B, the reliability determination unit 58 determines the contrast based on a brightness distribution of the image in the block BL. For example, the reliability determination unit 58 determines a difference between a maximum value and a minimum value of brightness of the image, as an evaluation value of the contrast. Note that the reliability determination unit 58 may use a standard deviation of the brightness distribution of the image as the evaluation value of the contrast. In a case where the brightness distribution of the image is used for determination of the contrast in this way, it is preferable to perform sensitivity correction on the image.

In addition, the reliability determination unit 58 may determine the contrast based on a shape of the correlation curve obtained by the correlation calculation processing. In this case, for example, the reliability determination unit 58 can set, as the evaluation value of the contrast, a difference between the maximum value and the minimum value of the correlation curve, a standard deviation, the number of the minimum values, the number of the maximum values, or a combination thereof. Note that, in a case where the image includes a repeating pattern of vertical lines or the like and thus the S/N ratio in the image is high, a plurality of minimum values may appear in the correlation curve. For this reason, in addition to the number of the minimum values of the correlation curve, it is preferable to use a difference between the maximum value and the minimum value of the correlation curve, as the evaluation value of the contrast. In a case where the contrast is low, the number of the minimum values increases, and the difference between the maximum value and the minimum value decreases.

Note that the same modification as the first modification example illustrated in FIG. 20 may be applied to the reliability determination processing according to the present modification example. That is, the nearest value may be set as the defocus amount DFa in a case where the number of the low-contrast blocks is smaller than the second threshold value, and the median value may be set as the defocus amount DFa in a case where the number of the low-contrast blocks is equal to or larger than the second threshold value.

### Fourth Modification Example

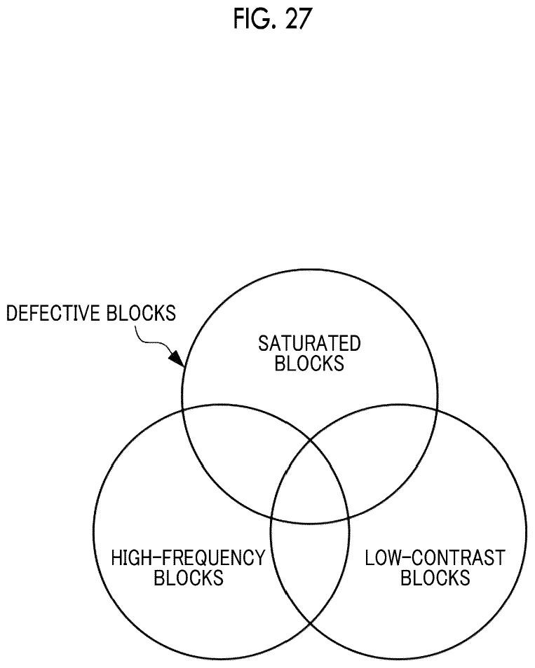

In the above-described embodiment, a factor related to the reliability is the saturation. In the second modification example, a factor related to the reliability is a frequency component, and in the third modification example, a factor related to the reliability is the contrast. In the present modification example, factors related to the reliability are the saturation, the frequency component, and the contrast. Specifically, as illustrated in FIG. 27, in a case where the block BL corresponds to at least any one of the saturated block described in the embodiment, the high-frequency block described in the second modification example, or the low-contrast block described in the third modification example, the reliability determination unit 58 determines that the block BL is a defective block.

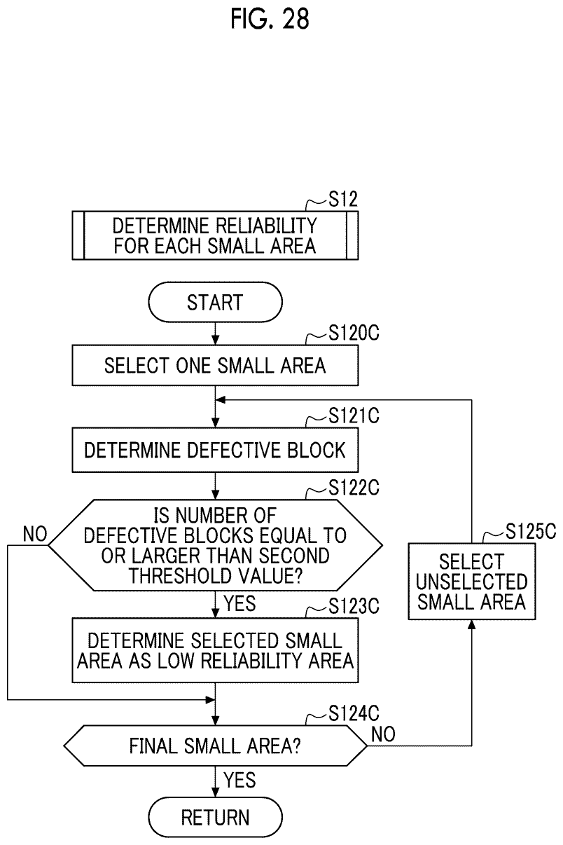

FIG. 28 illustrates reliability determination processing according to the fourth modification example. In step S120C to step S125C illustrated in FIG. 28, only step S121C and step S122C are different from step S120 to step S125 illustrated in FIG. 18. In step S121C, the reliability determination unit 58 determines whether or not each of the blocks BL included in the selected small area SA is a defective block. In step S122C, the reliability determination unit 58 determines whether or not the number of the defective blocks included in the selected small area SA is equal to or larger than a second threshold value. Subsequent processing is the same as that of the above-described embodiment.

In the present modification example, the selection unit 59 selects, as the driving defocus amount DFd, the nearest value or the median value of the plurality of defocus amounts DFa based on the number of the saturated blocks, the number of high-frequency blocks, the number of the low-contrast blocks, and the number of the defective blocks. For example, in a case where at least any one of the number of the saturated blocks, the number of the high-frequency blocks, the number of the low-contrast blocks, or the number of the defective blocks is equal to or larger than a first threshold value, the selection unit 59 selects the median value as the driving defocus amount DFd. In a case where all of the number of the saturated blocks, the number of the high-frequency blocks, the number of the low-contrast blocks, and the number of the defective blocks are smaller than the first threshold value, the selection unit 59 selects the nearest value as the driving defocus amount DFd.

Note that the same modification as the first modification example illustrated in FIG. 20 may be applied to the reliability determination processing according to the present modification example. That is, the nearest value may be set as the defocus amount DFa in a case where the number of the defective blocks is smaller than the second threshold value, and the median value may be set as the defocus amount DFa in a case where the number of the defective blocks is equal to or larger than the second threshold value.

In the present modification example, the reliability is determined by using a plurality of factors, and thus the focusing accuracy is further improved.

### Fifth Modification Example

In a case where the exposure condition in the focus control is a condition such as low brightness in which the S/N ratio is deteriorated, it is preferable to select the median value from the plurality of defocus amounts DFb acquired for each block BL (hereinafter, referred to as “inter-block median”) rather than selecting the median value from the plurality of defocus amounts DFa acquired for each small area SA as in the embodiment (hereinafter, referred to as “inter-area median”).

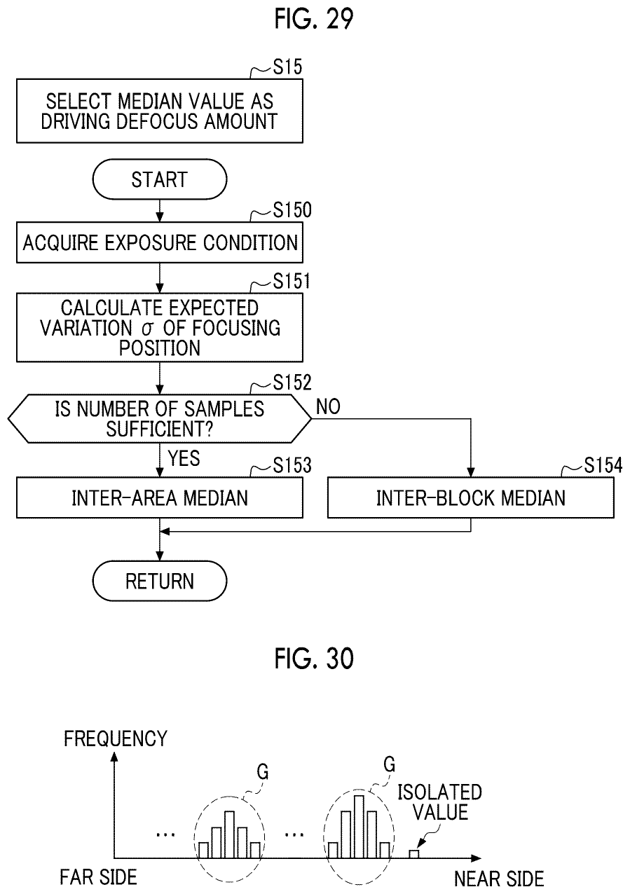

FIG. 29 illustrates median value selection processing (step S15) according to a fifth modification example. In step S15, first, the selection unit 59 acquires the exposure condition (the F number, the shutter speed, the ISO sensitivity, and the like) in the focus control (step S150). Next, the selection unit 59 calculates an expected variation σ of the focusing position based on the acquired exposure condition (step S151). The variation σ is a standard deviation, and is represented by a unit in which the depth of field is set to 1.

Next, the selection unit 59 determines whether or not the number of samples for obtaining the median value is sufficient based on the variation σ (step S152). The number of samples is the number of defocus amounts DFb acquired from one small area SA. That is, the number of samples is the number obtained by multiplying the number of blocks BL included in one small area SA by the number of filters FL used in the filtering processing described above.

In a case where σ>3 is satisfied, the selection unit 59 determines that the number of samples is sufficient (YES in step S152), and executes the above-described inter-area median (step S153). On the other hand, in a case where σ≤3 is satisfied, the selection unit 59 determines that the number of samples is not sufficient (NO in step S152), and executes the above-described inter-block median (step S154).

Hereinafter, a relationship between the variation (standard deviation) σ and the number of samples n will be described. First, an error range E of the focusing position is represented by Expression (1) in a case where a reliability coefficient in the section estimation is 95% and a standard error is SE.

$$E = 1.96 \times S E \qquad ( 1 )$$

Since the standard error SE is σ/sqrt(n), the error range E is represented by Expression (2) using the variation σ and the number n of samples.

$$E = 1.96 \times σ / sqrt ( n ) \qquad ( 2 )$$

Under a condition that the error range E is narrower than the depth of field, the relationship between the variation σ and the number n of samples is represented by Expression (3).

$$n > {( 1.96 \times σ )}^{2} \qquad ( 3 )$$

According to Expression (3), it can be seen that, in a case where the variation σ is three times (that is, σ=3) the depth of field, it is necessary to set n>34.6 in order to ensure the reliability of the median value selected from the sample. In a case where a determination criterion is set to σ=3 as described above, it is preferable to set the number n of samples to approximately 35.

### For Median Value

In the present disclosure, the median value is not limited to a value at which the rank is strictly in the center in the frequency distribution, and also includes a value at which the rank is in the vicinity of the center.

### For Nearest Value

In the present disclosure, the nearest value is not limited to a value on the most NEAR side in the frequency distribution. For example, since an isolated value positioned on the most NEAR side in the frequency distribution may be an abnormal value, the nearest value may be obtained from the distribution other than such an isolated value.

For example, as illustrated in FIG. 30, in a case where an isolated value is present on the most NEAR side in the frequency distribution and the distribution excluding the isolated value is divided into a plurality of groups G, one value selected from the group G on the most NEAR side may be set as the nearest value. In this case, for example, it is preferable to select a most-frequent value or an average value of the distribution in the group G on the most NEAR side, as the nearest value. Note that it is preferable to determine a set of values that exist at intervals of Y % or less of the depth of field as one group G. In addition, in order to prevent one group G from being a large set, it is preferable to exclude one group G of which a distance from the most NEAR side is other than Z % of the depth of field. In a case where the group G is defined as described above, it is preferable to determine that a value not belonging to any group G is an isolated value.

### Other Modification Examples

Note that, in the above-described embodiment, the display controller 53 causes the display 15 to display the image. On the other hand, instead of the display 15 or together with the display 15, the display controller 53 may cause the finder 14 to display the image. In this case, the focus control device may be configured to allow the user to designate the AF area RA via a visual line input device.

The technology of the present disclosure is not limited to the digital camera and can also be applied to electronic devices such as a smartphone and a tablet terminal having an imaging function.

In the above-described embodiment, various processors to be described below can be used as the hardware structure of the controller using the processor 40 as an example. The above-described various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The controller may be configured by one of these various processors or a combination of two or more of the processors of the same type or different types (for example, a combination of a plurality of FPGAs or a combination of a CPU and an FPGA). Alternatively, a plurality of controllers may be configured with one processor.

A plurality of examples in which a plurality of controllers are configured as one processor can be considered. As a first example, there is an aspect in which one or more CPUs and software are combined to configure one processor and the processor functions as a plurality of controllers, as represented by a computer such as a client and a server. As a second example, there is an aspect in which a processor that implements the functions of the entire system, which includes a plurality of controllers, with one IC chip is used, as represented by system on chip (SOC). In this way, the controller can be configured by using one or more of the above-described various processors as the hardware structure.

Furthermore, more specifically, it is possible to use an electrical circuit in which circuit elements such as semiconductor elements are combined, as the hardware structure of these various processors.

In addition, the program may be stored in a non-transitory computer readable storage medium.

The described contents and the illustrated contents are detailed explanations of a part according to the technique of the present disclosure, and are merely examples of the technique of the present disclosure. For example, the descriptions related to the configuration, the function, the operation, and the effect are descriptions related to examples of a configuration, a function, an operation, and an effect of a part according to the technique of the present disclosure. Therefore, it goes without saying that, in the described contents and illustrated contents, unnecessary parts may be deleted, new components may be added, or replacements may be made without departing from the spirit of the technique of the present disclosure. Further, in order to avoid complications and facilitate understanding of the part according to the technique of the present disclosure, in the described contents and illustrated contents, descriptions of technical knowledge and the like that do not require particular explanations to enable implementation of the technique of the present disclosure are omitted.

All documents, patent applications, and technical standards described in this specification are incorporated herein by reference to the same extent as in a case where each document, each patent application, and each technical standard are specifically and individually described by being incorporated by reference.

The following technology can be understood by the above description.

### Appendix 1

A focus control device that determines a defocus amount for driving a focus lens, the focus control device including:
a processor; and
a memory,
in which the processor is configured to:
   obtain, in a state where a plurality of areas are set in an imaging region, the number of the areas of which reliabilities of defocus amounts obtained from the plurality of areas are low; and
   determine the defocus amount for driving the focus lens based on an index related to a plurality of the defocus amounts in a case where the number is equal to or larger than a first threshold value.

### Appendix 2

The focus control device according to Appendix 1,
in which the index is an index based on a frequency of the plurality of defocus amounts.

### Appendix 3

The focus control device according to Appendix 1 or 2,
in which the processor is configured to determine a median value of the plurality of defocus amounts as the defocus amount for driving the focus lens.

### Appendix 4

The focus control device according to any one of Appendixes 1 to 3,
in which the processor is configured to determine the defocus amount for driving the focus lens based on a distance to a subject corresponding to the defocus amount in a case where the number is smaller than the first threshold value.

### Appendix 5

The focus control device according to any one of Appendixes 1 to 4,
in which the processor is configured to determine a nearest value of the plurality of defocus amounts as the defocus amount for driving the focus lens in a case where the number is smaller than the first threshold value.

### Appendix 6

The focus control device according to any one of Appendixes 1 to 5,
in which the processor is configured to:
   divide each of the plurality of areas into a plurality of blocks, and determine whether or not each of the plurality of blocks is a defective block based on a content rate of a signal that affects a decrease in the reliability and is included in each of the blocks; and
   determine that the reliability is low in a case where the number of the defective blocks is equal to or larger than a second threshold value.

### Appendix 7

The focus control device according to Appendix 6,
in which the signal that affects the decrease in the reliability is a signal that exceeds a limit of performance of an imaging element.

### Appendix 8

The focus control device according to any one of Appendixes 1 to 5,
in which the reliability is related to saturations of a plurality of pixels included in the area, and
the processor is configured to determine the reliability based on the saturations.

### Appendix 9

The focus control device according to Appendix 8,
in which the processor is configured to:
   divide each of the plurality of areas into a plurality of blocks, and determine whether or not each of the blocks is a saturated block based on a content rate of the saturated pixels in each of the blocks; and
   determine that the reliability is low in a case where the number of the saturated blocks is equal to or larger than a second threshold value.

### Appendix 10

The focus control device according to Appendix 9,
in which the processor is configured to:
   determine the area in which the number of the saturated blocks is equal to or larger than the second threshold value, as a first area; and
   set a median value of defocus amounts corresponding to the plurality of blocks included in the first area, as a defocus amount of the first area.

### Appendix 11

The focus control device according to Appendix 10,
in which the processor is configured to:
   determine the area in which the number of the saturated blocks is smaller than the second threshold value, as a second area; and
   set a nearest value of defocus amounts corresponding to the plurality of blocks included in the second area, as a defocus amount of the second area.

### Appendix 12

The focus control device according to any one of Appendixes 1 to 5,
in which the processor is configured to:
   perform a plurality of pieces of filtering processing of which frequency characteristics are different on a plurality of pixels included in the area; and
   determine the reliability based on evaluation values obtained by the plurality of pieces of filtering processing.

### Appendix 13

The focus control device according to Appendix 12,
in which the processor is configured to:
   divide each of the plurality of areas into a plurality of blocks, and determine whether or not each block is a high-frequency block based on the evaluation values for each block; and
   determine that the reliability is low in a case where the number of the high-frequency blocks is equal to or larger than a second threshold value.

### Appendix 14

The focus control device according to Appendix 13,
in which the processor is configured to:
   determine the area in which the number of the high-frequency blocks is equal to or larger than the second threshold value, as a first area; and
   set a median value of defocus amounts corresponding to the plurality of blocks included in the first area, as a defocus amount of the first area.

### Appendix 15

The focus control device according to Appendix 14,
in which the processor is configured to:
   determine the area in which the number of the high-frequency blocks is smaller than the second threshold value, as a second area; and
   set a nearest value of defocus amounts corresponding to the plurality of blocks included in the second area, as a defocus amount of the second area.

### Appendix 16

The focus control device according to any one of Appendixes 13 to 15,
in which the processor is configured to:
   calculate a first defocus amount by performing correlation calculation based on first two-dimensional images generated by performing first filtering processing on two-dimensional images represented by a plurality of pixels included in the block;
   calculate a second defocus amount by performing correlation calculation based on first one-dimensional images generated by performing the first filtering processing on one-dimensional images obtained by performing vertical addition on the two-dimensional images;
   calculate a third defocus amount by performing correlation calculation based on second two-dimensional images generated by performing, on the two-dimensional images, second filtering processing having different frequency characteristics from the first filtering processing;
   calculate a fourth defocus amount by performing correlation calculation based on second one-dimensional images generated by performing the second filtering processing on the one-dimensional images; and
   determine that the block is the high-frequency block in a case where a difference between the first defocus amount and the third defocus amount is larger than any one of a difference between the first defocus amount and the second defocus amount or a difference between the third defocus amount and the fourth defocus amount.

### Appendix 17

The focus control device according to any one of Appendixes 1 to 5,
in which the reliability is related to contrast of a plurality of pixels included in the area, and
the processor is configured to determine the reliability based on an evaluation value related to the contrast.

### Appendix 18

The focus control device according to Appendix 17,
in which the processor is configured to:
   divide each of the plurality of areas into a plurality of blocks, and determine whether or not each block is a low-contrast block based on the evaluation value for each block; and
   determine that the reliability is low in a case where the number of the low-contrast blocks is equal to or larger than a second threshold value.

### Appendix 19

The focus control device according to Appendix 18,
in which the processor is configured to:
   determine the area in which the number of the low-contrast blocks is equal to or larger than the second threshold value, as a first area; and
   set a median value of defocus amounts corresponding to the plurality of blocks included in the first area, as a defocus amount of the first area.

### Appendix 20

The focus control device according to Appendix 19,
in which the processor is configured to:
   determine the area in which the number of the low-contrast blocks is smaller than the second threshold value, as a second area; and
   set a nearest value of defocus amounts corresponding to the plurality of blocks included in the second area, as a defocus amount of the second area.

### Appendix 21

The focus control device according to Appendix 18 or 19,
in which the processor is configured to determine whether or not the block is the low-contrast block for each block based on a shape of a correlation curve obtained by performing correlation calculation based on a brightness distribution of the plurality of pixels included in the block or the plurality of pixels included in the block.

### Appendix 22

An imaging apparatus including:
the focus control device according to any one of Appendixes 1 to 21; and
an imaging element.

What is claimed is:

1. A focus control device that determines a defocus amount for driving a focus lens, the focus control device comprising:
a processor; and
a memory,
wherein the processor is configured to:
obtain, in a state where a plurality of areas are set in an imaging region, the number of the areas of which reliabilities of defocus amounts obtained from the plurality of areas are low; and
determine the defocus amount for driving the focus lens based on an index related to a plurality of the defocus amounts in a case where the number is equal to or larger than a first threshold value.

2. The focus control device according to claim 1,
wherein the index is an index based on a frequency of the plurality of defocus amounts.

3. The focus control device according to claim 1,
wherein the processor is configured to determine a median value of the plurality of defocus amounts as the defocus amount for driving the focus lens.

4. The focus control device according to claim 1,
wherein the processor is configured to determine the defocus amount for driving the focus lens based on a distance to a subject corresponding to the defocus amount in a case where the number is smaller than the first threshold value.

5. The focus control device according to claim 1,
wherein the processor is configured to determine a nearest value of the plurality of defocus amounts as the defocus amount for driving the focus lens in a case where the number is smaller than the first threshold value.

6. The focus control device according to claim 1,
wherein the processor is configured to:
divide each of the plurality of areas into a plurality of blocks, and determine whether or not each of the plurality of blocks is a defective block based on a content rate of a signal that affects a decrease in the reliability and is included in each of the blocks; and
determine that the reliability is low in a case where the number of the defective blocks is equal to or larger than a second threshold value.

7. The focus control device according to claim 6,
wherein the signal that affects the decrease in the reliability is a signal that exceeds a limit of performance of an imaging element.

8. The focus control device according to claim 1,
wherein the reliability is related to saturations of a plurality of pixels included in the area, and
the processor is configured to determine the reliability based on the saturations.

9. The focus control device according to claim 8,
wherein the processor is configured to:
divide each of the plurality of areas into a plurality of blocks, and determine whether or not each of the blocks is a saturated block based on a content rate of the saturated pixels in each of the blocks; and
determine that the reliability is low in a case where the number of the saturated blocks is equal to or larger than a second threshold value.

10. The focus control device according to claim 9,
wherein the processor is configured to:
determine the area in which the number of the saturated blocks is equal to or larger than the second threshold value, as a first area; and
set a median value of defocus amounts corresponding to the plurality of blocks included in the first area, as a defocus amount of the first area.

11. The focus control device according to claim 10,
wherein the processor is configured to:
determine the area in which the number of the saturated blocks is smaller than the second threshold value, as a second area; and
set a nearest value of defocus amounts corresponding to the plurality of blocks included in the second area, as a defocus amount of the second area.

12. The focus control device according to claim 1,
wherein the processor is configured to:
perform a plurality of pieces of filtering processing of which frequency characteristics are different on a plurality of pixels included in the area; and
determine the reliability based on evaluation values obtained by the plurality of pieces of filtering processing.

13. The focus control device according to claim 12,
wherein the processor is configured to:
divide each of the plurality of areas into a plurality of blocks, and determine whether or not each block is a high-frequency block based on the evaluation values for each block; and
determine that the reliability is low in a case where the number of the high-frequency blocks is equal to or larger than a second threshold value.

14. The focus control device according to claim 13,
wherein the processor is configured to:
determine the area in which the number of the high-frequency blocks is equal to or larger than the second threshold value, as a first area; and
set a median value of defocus amounts corresponding to the plurality of blocks included in the first area, as a defocus amount of the first area.

15. The focus control device according to claim 14,
wherein the processor is configured to:
determine the area in which the number of the high-frequency blocks is smaller than the second threshold value, as a second area; and
set a nearest value of defocus amounts corresponding to the plurality of blocks included in the second area, as a defocus amount of the second area.

16. The focus control device according to claim 13,
wherein the processor is configured to:
calculate a first defocus amount by performing correlation calculation based on first two-dimensional images generated by performing first filtering processing on two-dimensional images represented by a plurality of pixels included in the block;
calculate a second defocus amount by performing correlation calculation based on first one-dimensional images generated by performing the first filtering processing on one-dimensional images obtained by performing vertical addition on the two-dimensional images;
calculate a third defocus amount by performing correlation calculation based on second two-dimensional images generated by performing, on the two-dimensional images, second filtering processing having different frequency characteristics from the first filtering processing;
calculate a fourth defocus amount by performing correlation calculation based on second one-dimensional images generated by performing the second filtering processing on the one-dimensional images; and
determine that the block is the high-frequency block in a case where a difference between the first defocus amount and the third defocus amount is larger than any one of a difference between the first defocus amount and the second defocus amount or a difference between the third defocus amount and the fourth defocus amount.

17. The focus control device according to claim 1,
wherein the reliability is related to contrast of a plurality of pixels included in the area, and
the processor is configured to determine the reliability based on an evaluation value related to the contrast.

18. The focus control device according to claim 17,
wherein the processor is configured to:
divide each of the plurality of areas into a plurality of blocks, and determine whether or not each block is a low-contrast block based on the evaluation value for each block; and
determine that the reliability is low in a case where the number of the low-contrast blocks is equal to or larger than a second threshold value.

19. The focus control device according to claim 18,
wherein the processor is configured to:
determine the area in which the number of the low-contrast blocks is equal to or larger than the second threshold value, as a first area; and
set a median value of defocus amounts corresponding to the plurality of blocks included in the first area, as a defocus amount of the first area.

20. The focus control device according to claim 19,
wherein the processor is configured to:
determine the area in which the number of the low-contrast blocks is smaller than the second threshold value, as a second area; and
set a nearest value of defocus amounts corresponding to the plurality of blocks included in the second area, as a defocus amount of the second area.

21. The focus control device according to claim 18,
wherein the processor is configured to determine whether or not the block is the low-contrast block for each block based on a shape of a correlation curve obtained by performing correlation calculation based on a brightness distribution of the plurality of pixels included in the block or the plurality of pixels included in the block.

22. An imaging apparatus comprising:
the focus control device according to claim 1; and
an imaging element.

23. A focus control method of determining a defocus amount for driving a focus lens, the focus control method comprising:
obtaining, via a processor, in a state where a plurality of areas are set in an imaging region, the number of the areas of which reliabilities of defocus amounts obtained from the plurality of areas are low; and
determining, via the processor, the defocus amount for driving the focus lens based on an index related to a plurality of the defocus amounts in a case where the number is equal to or larger than a first threshold value.

24. A non-transitory computer-readable storage medium storing a program causing a processor to execute processing of determining a defocus amount for driving a focus lens, the processing comprising:
obtaining, in a state where a plurality of areas are set in an imaging region, the number of the areas of which reliabilities of defocus amounts obtained from the plurality of areas are low; and
determining the defocus amount for driving the focus lens based on an index related to a plurality of the defocus amounts in a case where the number is equal to or larger than a first threshold value.
